(19) United States
(12) Patent Application Publication
(10) Pub. No.: US 2026/0322711 A1
(43) Pub. Date: Oct. 15, 2026

(54) NETWORK ELEMENT INTERACTION-BASED MODEL TRAINING METHOD AND APPARATUS, MEDIUM, AND ELECTRONIC DEVICE

(71) Applicant: Tencent Technology (Shenzhen) Company Limited, Shenzhen (CN)

(72) Inventors: Yuhang JIA, Shenzhen (CN); Yixue LEI, Shenzhen (CN)

(73) Assignee: Tencent Technology (Shenzhen) Company Limited, Shenzhen (CN)

(21) Appl. No.: 19/687,272

(22) Filed: May 26, 2026

Related U.S. Application Data
(63) Continuation of application No. PCT/CN2025/074265, filed on Jan. 23, 2025.

(30) Foreign Application Priority Data
Feb. 8, 2024 (CN) 202410178138.4

(51) Int. Cl. H04L 41/16; H04L 67/53; H04L 67/55

(52) U.S. Cl. CPC H04L 41/16; H04L 67/53; H04L 67/55

(57) ABSTRACT

A method includes selecting a publisher network element that is configured to establish an information subscription relationship with a subscriber network element, the information subscription relationship indicating that the publisher network element provides data analysis information related to original data of subscription content for the subscriber network element; performing data alignment to obtain identification information of intersection data comprising the same identification information between original data possessed by the subscriber network element and the publisher network element; selecting publisher sample data from the publisher network element based on the identification information of the intersection data; updating, based on the publisher sample data, a machine learning model, to obtain model intermediate information of the publisher network element corresponding to the data analysis information; updating the machine learning model corresponding to the subscription content based on the model intermediate information of the publisher network element.

### CROSS-REFERENCE TO RELATED APPLICATION(S)

This application is a bypass continuation application of International Patent Application No. PCT/CN 2025/074265, filed on Jan. 23, 2025, which claims priority to and is based on Chinese Patent Application No. 202410178138.4, filed on Feb. 8, 2024, the disclosures of which are incorporated herein in their entireties by reference.

### FIELD

Some embodiments of the present disclosure relate to the field of communication and artificial intelligence technologies, and specifically, to a network element interaction-based model training method and apparatus, a computer-readable medium, an electronic device, and a computer program product.

### BACKGROUND

In a mobile communication network, various functional entities may not share system data due to privacy and security concerns unless the system data is encrypted or appropriate verification procedures are implemented. As it may be difficult to have access to the system data due to such concerns, a large amount of system data cannot be fully used in a training process of a machine learning model, resulting in poor performance of a trained machine learning model.

Information disclosed in this Background section was either known to the inventors before achieving the present disclosure or represents technical information acquired during the development process. Therefore, it may contain information that does not constitute prior art known to the public.

### SUMMARY

Some embodiments of the present disclosure provide a network element interaction-based model training method and apparatus, a computer-readable medium, an electronic device, and a computer program product, to improve a utilization rate of system data in a mobile communication network, and further improve performance of a machine learning model.

According to some embodiments of the present disclosure, a method for network element interaction-based model updating includes selecting, from a mobile communication network, a publisher network element that is configured to establish an information subscription relationship with a subscriber network element, the information subscription relationship indicating that the publisher network element provides data analysis information related to original data of subscription content for the subscriber network element; performing data alignment between the subscriber network element and the publisher network element, to obtain identification information of intersection data, the intersection data including the same identification information between original data possessed by the subscriber network element and original data possessed by the publisher network element; selecting publisher sample data from the publisher network element based on the identification information of the intersection data; updating, based on the publisher sample data, a machine learning model corresponding to the subscription content, to obtain model intermediate information of the publisher network element, the model intermediate information of the publisher network element corresponding to the data analysis information; transmitting the model intermediate information of the publisher network element to the subscriber network element; and updating, on the subscriber network element, the machine learning model corresponding to the subscription content based on the model intermediate information of the publisher network element.

According to some embodiments of the present disclosure, an apparatus for network element interaction-based model updating includes at least one memory configured to store computer program code; and at least one processor configured to read the program code and operate as instructed by the program code. The program code includes network element selection code configured to cause the at least one processor to select, from a mobile communication network, a publisher network element configured to establish an information subscription relationship with a subscriber network element, the information subscription relationship indicating that the publisher network element provides data analysis information related to original data of subscription content for the subscriber network element; data alignment code configured to cause the at least one processor to perform data alignment between the subscriber network element and the publisher network element, to obtain identification information of intersection data, the intersection data including the same identification information between original data possessed by the subscriber network element and original data possessed by the publisher network element; sample selection code configured to cause the at least one processor to, select publisher sample data from the publisher network element based on the identification information of the intersection data; and update, based on the publisher sample data, a machine learning model corresponding to the subscription content, to obtain model intermediate information of the publisher network element, the model intermediate information of the publisher network element corresponding to the data analysis information; model updating code configured to cause the at least one processor to transmit the model intermediate information of the publisher network element to the subscriber network element; and update, on the subscriber network element, the machine learning model corresponding to the subscription content, based on the model intermediate information of the publisher network element.

According to some embodiments of the present disclosure, a non-transitory computer-readable storage medium, storing computer program code, when executed by at least one processor, causes the at least one processor to at least select, from a mobile communication network, a publisher network element that is configured to establish an information subscription relationship with a subscriber network element, the information subscription relationship indicating that the publisher network element provides data analysis information related to original data of subscription content for the subscriber network element; perform data alignment between the subscriber network element and the publisher network element, to obtain identification information of intersection data, the intersection data including the same identification information between original data possessed by the subscriber network element and original data possessed by the publisher network element; select publisher sample data from the publisher network element based on the identification information of the intersection data; update, based on the publisher sample data, a machine learning model corresponding to the subscription content, to obtain model intermediate information of the publisher network element, the model intermediate information of the publisher network element corresponding to the data analysis information; transmit the model intermediate information of the publisher network element to the subscriber network element; and update, on the subscriber network element, the machine learning model corresponding to the subscription content based on the model intermediate information of the publisher network element.

Some embodiments of the present disclosure provide technical advantages or improvement in a technical field. For example, an information subscription relationship is established between different network elements, so that data analysis information can be shared between the different network elements while it is ensured that original data possessed by the network elements is kept from being leaked, thereby implementing training of a machine learning model by using the shared data analysis information. As a result, privacy security of data can be ensured, and performance of the machine learning model can also be improved. Therefore, wide applicability of the machine learning model in a mobile communication network can be improved.

### BRIEF DESCRIPTION OF THE DRAWINGS

The above and other aspects, features, and advantages of one or more embodiments of the present disclosure will be more apparent from the following description taken in conjunction with the accompanying drawings, in which:

FIG. 1 is a schematic diagram of a network architecture of a mobile communication network, in accordance with some embodiments of the present disclosure;

FIG. 2 is a schematic diagram of a network architecture, in accordance with some embodiments of the present disclosure;

FIG. 3 is a flowchart of a network element interaction-based model training method, in accordance with some embodiments of the present disclosure;

FIG. 4 is a flowchart of performing data alignment based on a trusted third party, in accordance with some embodiments of the present disclosure;

FIG. 5 is a flowchart of training a machine learning model based on a third-party network element, in accordance with some embodiments of the present disclosure;

FIG. 6 is a block diagram of an architecture of implementing network element interaction in an application, in accordance with some embodiments of the present disclosure;

FIG. 7 is a flowchart of direct interaction between two network elements in an application scenario, in accordance with some embodiments of the present disclosure;

FIG. 8 is a flowchart of interaction performed through a third-party network element in an application scenario, in accordance with some embodiments of the present disclosure;

FIG. 9 is a schematic block diagram of a structure of a network element interaction-based model training apparatus, in accordance with some embodiments of the present disclosure; and

FIG. 10 is a schematic block diagram of a structure of a computer system applicable to implement an electronic device, in accordance with some embodiments of the present disclosure.

### DETAILED DESCRIPTION

Exemplary implementations are described more comprehensively below with reference to the accompanying drawings. However, the exemplary implementations may be implemented in various forms, and are not to be understood as being limited to the examples described herein. Instead, the implementations are provided to make the present disclosure more thorough and complete, and fully convey the idea of the exemplary implementations to a person skilled in the art.

In addition, the described features, structures, or characteristics may be combined in one or more embodiments in any appropriate manner. In the following descriptions, many specific details are provided for comprehensive understanding of some embodiments of the present disclosure. However, a person of ordinary skill in the art is to be aware that the technical solutions in the present disclosure may be implemented without one or more of the particular details, or may be implemented by using another method, unit, apparatus, operation, or the like. In other cases, well-known methods, apparatuses, implementations, or operations are not shown or described in detail to avoid obscuring aspects of the present disclosure.

The term, involved in the following description, “some embodiments” describes subsets of all possible embodiments, but “some embodiments” may be the same subset or different subsets of all the possible embodiments and may be combined with each other without conflict.

The operations, techniques, and processes described herein may be implemented via executable instructions or computer program code stored on computer-readable medium. Such computer program code may include distinct portions or modules, where each portion comprises a subset of the total instructions to perform specific operations.

The terms “a,” “an,” “the,” and similar referents in the context of describing the disclosed embodiments (especially in the claims) are to be construed to cover both singular and plural forms, unless otherwise indicated or clearly contradicted by context. The number of items in a plurality is at least two, but may be more when indicated explicitly or by context.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

Terms such as “set” (e.g., “a set of items”) or “subset” unless otherwise noted or contradicted by context, is to be construed as a nonempty collection including one or more members. Further, unless otherwise noted or contradicted by context, term “subset” of a corresponding set does not necessarily denote a proper subset of corresponding set, but subset and corresponding set may be equal.

An expression, “a and/or b” may be understood as including only a, only b and both a and b. Expressions “at least one of a, b, and c” and “at least one of a, b, or c” may be understood as including only a, only b, only c, both a and b, both a and c, both b and c, or all of a, b, and c. Also, expressions such as ‘a, b, or c’ may be understood as ‘at least one of a, b, or c’ unless explicitly stated otherwise, or unless the elements would only be understood as alternatives by a person ordinarily skilled in the art.

Further, unless stated otherwise or otherwise clear from context, phrase “based on” may refer to “based at least in part on” and not “based solely on.”

The terms “first,” “second,” “third,” and the like in the description and in the claims, if any, are used for distinguishing between similar elements and not necessarily for describing a sequential or chronological order. It is to be understood that the terms so used are interchangeable under appropriate circumstances.

With regard to the description of the drawings, similar reference numerals may be used to refer to similar or related components.

In some embodiments of the present disclosure, the term “module” or “unit” refers to a computer program having a predetermined function or a part of a computer program, and works together with other relevant parts to achieve a predetermined objective, and may be completely or partially implemented by using software, hardware (for example, a processing circuit or a memory), or a combination thereof. Similarly, one processor (or a plurality of processors or memories) may be configured to implement one or more modules or units. In addition, each module or unit may be a part of an overall module or unit including a function of the module or the unit.

Block diagrams shown in the accompanying drawings are merely functional entities and do not necessarily correspond to physically independent entities. To be specific, these functional entities may be implemented in a software form, or in one or more hardware modules or integrated circuits, or in different networks and/or processor apparatuses and/or microcontroller apparatuses.

Flowcharts shown in the accompanying drawings are merely exemplary descriptions, do not necessarily include all content and operations/steps, and are not necessarily performed in the described sequences either. For example, some operations/steps may be further divided, while some operations/steps may be combined or partially combined. Therefore, an actual performing sequence may change based on an actual situation.

Terms related to a mobile communication network involved in some embodiments of the present disclosure are explained below.
AF: Application function, which may alternatively be used as an application server (AS). The entity may implement a control plane function of a third-party application server, and perform interaction in an AF-NEF-PCF manner or an AF-PCF manner. The entity may further implement a user plane function, e.g., AS-IP transport network-UPF interface, of the third-party application server.
SMF: System management function, which is responsible for tunnel maintenance, IP address allocation and management, UPF selection, policy implementation, control in quality of service (QoS), charging data collection, roaming, and the like.
AMF: Access and mobility management function, which performs registration, connection, reachability, and mobility management, provides a session management and message transmission channel for a UE and the SMF, provides verification and authentication functions for a user to access, and is a core network control plane access point for a terminal and a radio.
PCF: Policy control function, which is a unified policy framework and provides a policy rule for a control plane function.
UPF: User plane function, which is configured for packet routing and forwarding, policy implementation, traffic reporting, and QoS processing.
NEF: Network exposure function, which is located between a 5G core network and an external third-party application function (or possibly some internal AFs), and responsible for management of exposed network data. All external applications need to use the NEF for access to internal data of the 5G core network. The NEF provides a corresponding security guarantee to ensure secure access form the external applications to a 3GPP network, and provides functions such as QoS customization exposure ability of the external applications, mobility state event subscription, and AF request distribution.
UE: User equipment. A terminal device may include one or more of a mobile terminal mobile phone APP, an in-vehicle IP camera, other terminal software, and the like.
NWDAF: Network data analytics function, which provides a specific network data analytics service for a network.
ADRF: Analytics data repository function. The functional entity is also introduced for implementing a network analytics function, and main functions are storage of network analytics data and collected data.
MFAF: Messaging framework adaptor function. A main function of this NF is to implement adaptation to a messaging framework, and a function of the messaging framework is not defined in 3GPP. The MFAF implements interaction between a DCCF and the messaging framework, transmits data that needs to be processed to the messaging framework, receives data processed by the messaging framework, and performs processing like formatting on related data. The NF is also introduced for implementing the network data analytics function.
AnLF: Analytics logical function, which is responsible for model inference, provides a common NWDAF service interface such as Nnwdaf_AnalyticsSubscription and Nnwdaf_AnalyticsInfo, and may generate an analysis result (including static statistical data and a dynamic inference result) based on a request of a consumer network element.
MTLF: Model training logical function, which is responsible for model training, and may provide a trained model for the AnLF. A model training process herein is not standardized (which means that a manufacturer has large space for creativity), and the AnLF is the only consumer network element of a service provided by the MTLF. A single NWDAF may integrate both the AnLF and the MTLF.

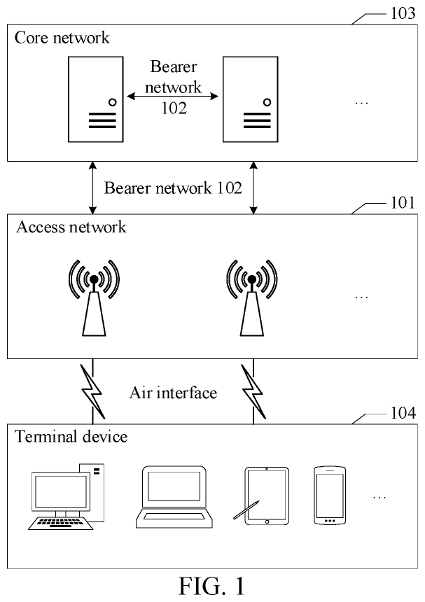

FIG. 1 is a schematic diagram of a network architecture of a mobile communication network to which the technical solutions in the present disclosure are applied.

As shown in FIG. 1, the mobile communication network mainly includes an access network 101, a bearer network 102, and a core network 103. The access network 101 is configured to connect a terminal device 104 like a mobile phone of a user to a network. The terminal device 104 is connected to a base station through an air interface. The bearer network 102 is configured to carry data transmission, for example, perform data transmission between network elements via an optical fiber. The core network 103 is a management center of the mobile communication network, and is a telecommunication-level router configured to perform data management such as location management, update, authentication, and connection on the terminal device 104.

The technical solutions in some embodiments of the present disclosure may be applied to various communication systems, for example, a global system for mobile communications (GSM), a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD) system, a universal mobile telecommunication system (UMTS), a worldwide interoperability for microwave access (WiMAX) communication system, a 5^{th} generation (5G) communication system, or a new radio (NR) communication system.

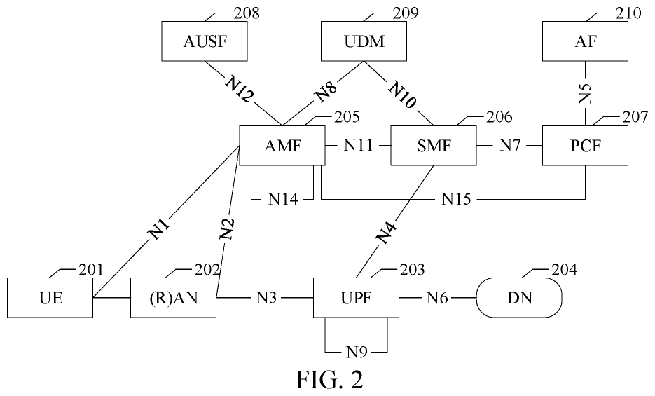

FIG. 2 is a schematic diagram of a network architecture to which some embodiments of the present disclosure is applicable. The following describes each part in the network architecture.

A user equipment (UE) 201 may include various handheld terminal devices, in-vehicle devices, and wearable devices that have a wireless communication function, for example, may include a device that may access a network such as a cellular phone, a smart phone, a wireless data card, a personal digital assistant (PDA), a notebook computer, a tablet computer, a wireless modem, a handheld device, a laptop computer, a cordless phone, a wireless local loop (WLL) station, or a machine-type communication (MTC) terminal.

An access network (AN) network element 202 is mainly responsible for functions such as radio resource management, service quality management, data compression, and encryption on an air interface side, is configured to provide a network access function for an authorized user equipment in a specific region, and can use transmission tunnels of different quality based on a level of the user equipment, a service requirement, and the like. In a radio access scenario, the access network network element 202 may alternatively be referred to as a radio access network (RAN) network element. The RAN network element can manage radio resources, provide an access service for the user equipment, and further complete forwarding of a control signal and user equipment data between the user equipment and a core network. The RAN network element may include base stations in various forms, for example, a macro base station, a micro base station (alternatively referred to as a small station), a relay station, and an access point. In systems using different radio access technologies, the RAN network element having a base station function may have different names. For example, in a 5^{th} generation (5G) system (5GS), the RAN network element is referred to as a gNB. In an LTE system, the RAN network element is referred to as an evolved NodeB (eNB or eNodeB). In a 3^{rd} generation (3G) system, the RAN network element is referred to as a NodeB.

A user plane network element 203 is responsible for functions such as encapsulation, routing, forwarding, and statistics of a user packet and quality of service (QoS) processing of user plane data. In the 5G communication system, the user plane network element may be a user plane function (UPF).

A data network network element 204 is configured to provide a network for data transmission. In the 5G communication system, the data network network element may be a data network (DN) network element.

An access and mobility management network element 205 is mainly configured for mobility management, access management, and the like, and may be configured to implement a function of a mobility management entity (MME) other than session management, for example, a function such as lawful detection and access authorization/authentication. In the 5G communication system, the access and mobility management network element may be an access and mobility management function (AMF).

A session management network element 206 is mainly configured for session management, Internet protocol (IP) address allocation and management of the user equipment, selection of a manageable user plane function, termination of policy control and charging function interfaces, downlink data notification, and the like. In the 5G communication system, the session management network element may be a session management function (SMF).

A policy control network element 207 is a unified policy framework configured for instructing a network behavior and provides policy rule information and the like for a control plane function network element (for example, the AMF or the SMF). In a 4G communication system, the policy control network element may be a policy and charging rules function (PCRF). In the 5G communication system, the policy control network element may be a policy control function (PCF).

An authentication server 208 is configured for an authentication service and key generation to implement bidirectional authentication for the user equipment, and supports a unified authentication framework. In the 5G communication system, the authentication server may be an authentication server function (AUSF).

A data management network element 209 is configured for user equipment identifier processing, access authentication, registration, mobility management, and the like. In the 5G communication system, the data management network element may be a unified data management (UDM) network element. In the 4G communication system, the data management network element may be a home subscriber server (HSS) network element.

An application network element 210 is configured to perform application-influenced data routing, access a network exposure function, interact with a policy framework to perform policy control, and the like. In the 5G communication system, the application network element may be an application function (AF).

Network storage network element is configured to maintain real-time information of all network function services in the network. In the 5G communication system, the network storage network element may be a network repository function (NRF).

In the network architecture shown in FIG. 2, the user equipment (UE) is connected to the AMF through an N1 interface, the (R)AN is connected to the AMF through an N2 interface, and the (R)AN is connected to the UPF through an N3 interface. The UPFs are connected to each other through an N9 interface, and the UPF is interconnected to the DN through an N6 interface. The SMF controls the UPF through an N4 interface. The AMF is connected to the SMF through an N11 interface. The AMF obtains user equipment subscription data from a UDM unit through an N8 interface, and the SMF obtains the user equipment subscription data from the UDM unit through an N10 interface.

The foregoing network element or function may be a network element in a hardware device, or may be a software function running on dedicated hardware, or a virtualization function instantiated on a platform (for example, a cloud platform). The foregoing network architecture applied to some embodiments of the present disclosure is merely an example for description, and a network architecture applicable to some embodiments of the present disclosure is not limited thereto. Any network architecture capable of implementing functions of the foregoing network elements is applicable to some embodiments of the present disclosure.

For example, in some network architectures, network function network element entities such as an AMF, an SMF, a PCF, an AUSF, and a UDM are all referred to as network functions (NFs). Alternatively, in some other network architectures, a set of network elements such as an AMF, an SMF, a PCF, an AUSF, and a UDM may be referred to as a control plane function network element.

Names of the interfaces between the network elements in FIG. 1 and FIG. 2 are merely examples. During specific implementation, the names of the interfaces may be other names. This is not limited in some embodiments of the present disclosure. Names of the network elements (for example, the SMF, the IF, and the UPF) included in FIG. 1 and FIG. 2 are merely examples, and do not constitute any limitation on functions of the network elements. In the 5GS and another future network, the foregoing network elements may alternatively have other names. This is not limited in some embodiments of the present disclosure. For example, in a 6G network, some or all of the foregoing network elements may use the terms in 5G, or may use other names. In addition, a name of a message (or signaling) transmitted between the network elements is merely an example, and does not constitute any limitation on a function of the message.

Technical solutions such as a network element interaction-based model training method, a network element interaction-based model training apparatus, a computer-readable medium, an electronic device, and a computer program product provided in the present disclosure are described in detail below with reference to specific implementations.

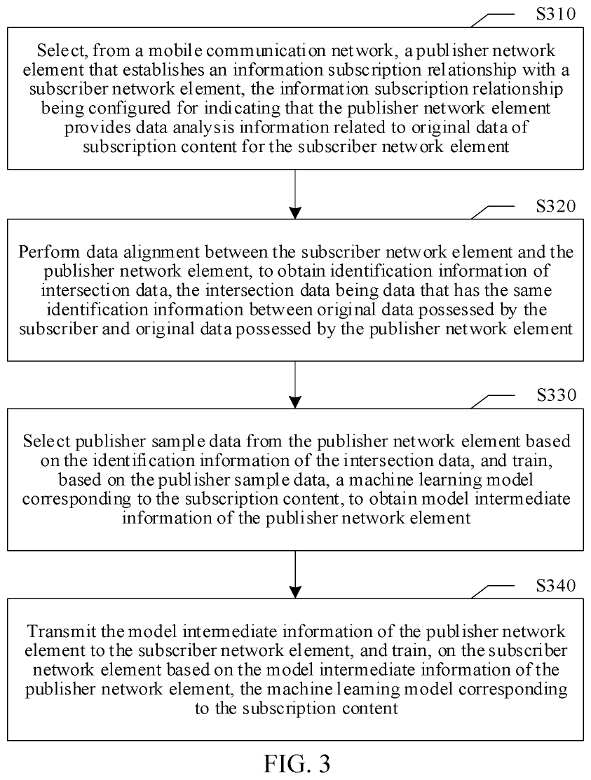

FIG. 3 is a flowchart of a network element interaction-based model training method according to some embodiments of the present disclosure. The network element interaction-based model training method may be performed by any one or more network elements in the mobile communication network shown in FIG. 2. As shown in FIG. 3, the network element interaction-based model training method may include S310 to S340.
S310: Select, from a mobile communication network, a publisher network element that establishes an information subscription relationship with a subscriber network element, the information subscription relationship being configured for indicating that the publisher network element provides data analysis information related to original data of subscription content for the subscriber network element.
S320: Perform data alignment between the subscriber network element and the publisher network element, to obtain identification information of intersection data, the intersection data being data that has the same identification information between original data possessed by the subscriber and original data possessed by the publisher network element.
S330: Select publisher sample data from the publisher network element based on the identification information of the intersection data, and train, based on the publisher sample data, a machine learning model corresponding to the subscription content, to obtain model intermediate information of the publisher network element.
S340: Transmit the model intermediate information of the publisher network element to the subscriber network element, and train, on the subscriber network element based on the model intermediate information of the publisher network element, the machine learning model corresponding to the subscription content.

In the network element interaction-based model training method provided in some embodiments of the present disclosure, an information subscription relationship is established between different network elements, so that data analysis information can be shared between the different network elements while it is ensured that original data possessed by the network elements is kept from being leaked, thereby implementing training of a machine learning model by using the shared data analysis information. In this way, privacy security of data can be ensured, and performance of the machine learning model can also be improved. Therefore, wide applicability of the machine learning model in a mobile communication network can be improved.

The following describes the network element interaction-based model training method in the present disclosure in detail with reference to a plurality of embodiments.

In S310, the publisher network element that establishes the information subscription relationship with the subscriber network element is selected from the mobile communication network, the information subscription relationship being configured for indicating that the publisher network element provides the data analysis information related to the original data of the subscription content for the subscriber network element.

The subscription content corresponds to an application requirement of the subscriber network element. For example, the subscriber network element needs to adjust corresponding service content based on network quality of the mobile communication network, but each network element in the mobile communication network usually does not share original data related to the network quality with another network element. Therefore, the subscriber network element may obtain data analysis information related to the network quality from the publisher network element by establishing the information subscription relationship, and may subsequently determine the network quality of the mobile communication network based on the data analysis information related to the network quality provided by one or more publisher network elements.

The data analysis information is derived data generated by analyzing, based on the subscription content, the original data possessed by the publisher network element. In an application scenario of the training of the machine learning model, the data analysis information, for example, may include derived data related to sample data and derived data related to a model. The derived data related to the sample data, for example, may include identification information of the sample data and a data feature extracted from the sample data. The derived data related to the model, for example, may include a model parameter obtained by performing model training through network elements or gradient information configured for updating the model parameter.

In some embodiments of the present disclosure, the subscriber network element is a network element outside a core network of the mobile communication network, and the publisher network element is a network element inside the core network of the mobile communication network. The information subscription relationship is established between the subscriber network element and the publisher network element, so that the data analysis information related to the original data of the subscription content may be provided by the network element inside the core network for the network element outside the core network. Therefore, derived data meeting an application requirement can be provided for an application node outside the core network on a premise that it is ensured that original data of the core network is not leaked.

In some embodiments of the present disclosure, the subscriber network element is an application function (AF) configured to implement an application-layer service, and the publisher network element is a network data analytics function (NWDAF) configured to provide a network data analytics service for the mobile communication network.

3 GPP R 18 23.700-80 provides 47 AI/ML-based solutions to support an AI/ML-based service/application. A 5GS network resource is used for AI/ML model and data distribution, transmission, and/or training of various applications. To detect a use status of the 5G network resource, a network resource utilization rate related to terminal performance (for example, a data throughput provided for a terminal) needs to be obtained, to support operations related to AI/ML model/data distribution and sharing of the applications.

In some related technologies, an application function (AF) has label data, but lacks network information of a core network, and the core network does not intend to share the network information with the application function (AF) or a service server. Consequently, the application function (AF) or the service server cannot accurately perform QoS or quality of experience (QoE) analysis.

With regard to this problem, in some embodiments of the present disclosure, the application function (AF) outside the core network is used as the subscriber network element, the network data analytics function (NWDAF) inside the core network is used as the publisher network element, and the application function (AF) and the network data analytics function (NWDAF) establish the information subscription relationship. Therefore, the application function (AF) can obtain the data analysis information of the original data from the network data analytics function (NWDAF), to ensure privacy security of core network data, and also meet a service requirement for detecting the use status of the 5G network resource by the application function (AF).

In some embodiments of the present disclosure, the network data analytics function (NWDAF) initiates a sample collection request to an operation administration and maintenance (OAM) in the mobile communication network; and obtains, based on the sample collection request, original data possessed by the network data analytics function (NWDAF).

In some embodiments of the present disclosure, the original data possessed by the network data analytics function includes channel quality indicator (CQI) information configured for indicating wireless channel quality. A CQI is an indicator used in a wireless communication system, and is configured for indicating the wireless channel quality. The CQI is usually used in wireless communication technologies such as long term evolution (LTE) and 5G, to facilitate dynamical adjustment of a modem parameter between a base station and a terminal device, so as to improve communication quality and a data transmission rate to the greatest extent. An indication of this type of information is analyzed and provided for the AF, to better serve a service, and make the service better adapt to complex network changes.

In some embodiments of the present disclosure, the selecting, from a mobile communication network, a publisher network element that establishes an information subscription relationship with a subscriber network element may further include: transmitting an information exposure request of the subscriber network element to a network exposure function (NEF) in the mobile communication network, the information exposure request carrying a network element identifier of the subscriber network element and the subscription content; and establishing, on the network exposure function, a mapping relationship between the network element identifier of the subscriber network element and the subscription content, and initiating, to the publisher network element based on the subscription content, an information subscription request for establishing the information subscription relationship.

The network element identifier of the subscriber network element is identification information configured for differentiating between different network elements. In some embodiments of the present disclosure, an information exchange channel is provided between the subscriber network element and the publisher network element through the network exposure function (NEF), and the mapping relationship between the network element identifier of the subscriber network element and the subscription content can be maintained through the network exposure function (NEF), so that an interaction matching relationship between the subscriber network element and the publisher network element can be effectively managed. Interaction efficiency is improved, and stability and security of information exchange can be ensured.

In some embodiments of the present disclosure, before the mapping relationship is established, on the network exposure function, between the network element identifier of the subscriber network element and the subscription content, permission verification may be performed on the subscriber network element based on the network element identifier of the subscriber network element, the permission verification being configured for determining whether the subscriber network element has a system access permission; if a verification result of the permission verification indicates that the verification fails, indicating that the subscriber network element does not have the system access permission, execution of the information exposure request of the subscriber network element may be rejected; and if the verification result of the permission verification indicates that the verification succeeds, indicating that the subscriber network element has the system access permission, execution of the operation of establishing, on the network exposure function, a mapping relationship between the network element identifier of the subscriber network element and the subscription content may be triggered.

In some embodiments of the present disclosure, before the information subscription relationship is established, the network exposure function (NEF) performs permission verification on the subscriber network element that initiates the request. The information subscription request is initiated to the publisher network element corresponding to the subscription content, only when the subscriber network element has the system access permission, so that information security of the core network can be improved.

In S320, data alignment is performed between the subscriber network element and the publisher network element, to obtain the identification information of intersection data, the intersection data being the data that has the same identification information between the original data possessed by the subscriber and the original data possessed by the publisher network element.

In some embodiments of the present disclosure, a method for performing data alignment between the subscriber network element and the publisher network element may include private set intersection, to be specific, a private calculation manner is used to learn of the intersection data between the original data on a premise that the original data is not transmitted between the subscriber network element and the publisher network element. A private set intersection method, for example, may include a Blind RSA-based PSI Protocol with linear complexity, a Diffie-Hellman-based solution, an oblivious transfer (OT)-based solution, or a Freedman private set intersection protocol.

In some embodiments of the present disclosure, to further improve reliability of privacy security of data, data alignment may be further performed on the subscriber network element and the publisher network element by configuring a trusted third party.

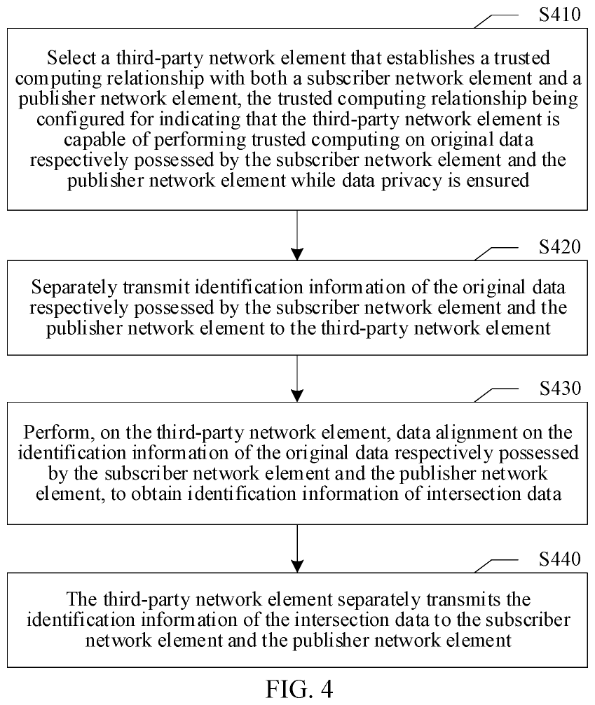

FIG. 4 is a flowchart of performing data alignment based on a trusted third party according to some embodiments of the present disclosure. As shown in FIG. 4, based on the foregoing embodiments, the method for performing data alignment between the subscriber network element and the publisher network element may include S410 to S440.
S410: Select a third-party network element that establishes a trusted computing relationship with both the subscriber network element and the publisher network element, the trusted computing relationship being configured for indicating that the third-party network element is capable of performing trusted computing on the original data respectively possessed by the subscriber network element and the publisher network element while data privacy is ensured.
S420: Separately transmit identification information of the original data respectively possessed by the subscriber network element and the publisher network element to the third-party network element.
S430: Perform, on the third-party network element, data alignment on the identification information of the original data respectively possessed by the subscriber network element and the publisher network element, to obtain the identification information of the intersection data.

In an embodiment, S440 may be further performed: The third-party network element separately transmits the identification information of the intersection data to the subscriber network element and the publisher network element.

Trusted computing is a computer system security technology in which cryptographic-based computing and protection coexist, to ensure detectability in an entire process. A principle of the trusted computing is active defense, and an entire link is subject to trusted authentication. Therefore, an application, an operating system, and hardware all need to be authorized for use. One of core targets of the trusted computing is to ensure integrity of the system and the application, so as to determine that the system or the software runs in a trusted status expected by a design target. Roots of trust are a basis of trust of a trusted computer system, and are classified into a root of trust for measurement (RTM, which is a piece of software first executed when a platform is started), a root of trust for storage (RTS, which is a group of a memory referred to as a platform configuration register and a storage root key in a trusted platform module chip), and a root of trust for reporting (RTR, which is the platform configuration register and an endorsement key in the trusted platform module chip). A chain of trust is a technical implementation solution of a trust measurement model. A trust relationship is extended from the root of trust to an entire computer system through the chain of trust.

A basic idea of the trusted computing is to ensure security through remote attestation and digital rights management. For example, in the computer system, a root of trust is first established, and then a chain of trust is established. Starting from the root of trust, to a hardware platform, to an operating system, and then to an application, each layer measures and authenticates a next layer, so that each layer trusts the next layer, to extend such trust to the entire computer system, thereby ensuring credibility of the entire computer system.

In some embodiments of the present disclosure, the selecting a third-party network element that establishes a trusted computing relationship with both the subscriber network element and the publisher network element may further include: obtaining a first set of network elements that establishes a trusted computing relationship with the subscriber network element and a second set of network elements that establishes a trusted computing relationship with the publisher network element; selecting, if there is a common network element between the first set of network elements and the second set of network elements, the common network element as the third-party network element; and selecting, through the network exposure function in the mobile communication network if there is no common network element between the first set of network elements and the second set of network elements, a temporary network element as the third-party network element.

In some embodiments of the present disclosure, the network element sets that establish the trusted computing relationships with different network elements are respectively maintained on the different network elements, so that when the trusted third-party network element needs to be selected, the common network element may be selected as the third-party network element by taking an intersection of the network element sets, thereby avoiding a case in which mutual trust between network elements needs to be repeatedly established each time the network elements interact with each other. In this way, efficiency of data alignment between the different network elements can be improved, and network resource consumption and computing resource consumption for data alignment can be reduced.

In some embodiments of the present disclosure, the temporary network element is a network element that is selected from a third set of network elements maintained by the network exposure function and that is different from both the first set of network elements and the second set of network elements, and the temporary network element establishes a trusted computing relationship having specified validity duration with both the subscriber network element and the publisher network element through the network exposure function.

The network exposure function may periodically select a network element whose security verification level reaches a specified standard from the mobile communication network to form the third set of network elements. When there is no common trusted network element between the subscriber network element and the publisher network element, the temporary network element may be directly selected from the third set of network elements. In addition, the temporary network element belongs to neither the first set of network elements nor the second set of network elements, so that when it is ensured that the network elements are basically trusted, collusive cheating between the temporary network element and either of the subscriber network element and the publisher network element can be avoided.

The temporary network element establishes the trusted computing relationship having the specified validity duration with both the subscriber network element and the publisher network element through the network exposure function. If the specified validity duration expires, the computing relationship needs to be reestablished, to ensure security and timeliness of the temporary network element.

In S330, the publisher sample data is selected from the publisher network element based on the identification information of the intersection data, and the machine learning model corresponding to the subscription content is trained based on the publisher sample data, to obtain the model intermediate information of the publisher network element.

In some embodiments of the present disclosure, for identification information of the same original data, the subscriber network element and the publisher network element may respectively possess different data content of the original data. For example, for the same terminal device, data possessed by the subscriber network element is a battery level of the terminal device, and data possessed by the publisher network element is a guaranteed bit rate (GBR) allocated by the mobile communication network to the terminal device. A machine learning model configured to predict device performance of the terminal device may be separately trained based on the sample data respectively possessed by the subscriber network element and the publisher network element.

The publisher sample data is data that is in the original data possessed by the publisher network element and that has the identification information of the intersection data. The model intermediate information of the publisher network element belongs to data analysis information. The model intermediate information, for example, may be the model parameter obtained in a model training process or the gradient information configured for updating the model parameter.

In S340, the model intermediate information of the publisher network element is transmitted to the subscriber network element, and the machine learning model corresponding to the subscription content is trained on the subscriber network element based on the model intermediate information of the publisher network element.

In some embodiments of the present disclosure, after receiving the model intermediate information transmitted by the publisher network element, the subscriber network element may continue to train, based on the model intermediate information and the sample data possessed by the subscriber network element, the machine learning model corresponding to the subscription content, to implement cooperative training of the machine learning model on a premise that the original data is not disclosed.

In some embodiments of the present disclosure, a method of the training, on the subscriber network element based on the model intermediate information of the publisher network element, the machine learning model corresponding to the subscription content may include: selecting subscriber sample data from the subscriber network element based on the identification information of the intersection data, the subscriber sample data being data that is in the original data possessed by the subscriber network element and that has the identification information of the intersection data; training, based on the subscriber sample data, the machine learning model corresponding to the subscription content, to obtain model intermediate information of the subscriber network element; and training, on the subscriber network element based on the model intermediate information of the subscriber network element and the model intermediate information of the publisher network element, the machine learning model corresponding to the subscription content.

In some embodiments of the present disclosure, in addition to using the model intermediate information provided by the publisher network element, the subscriber network element may also perform synchronous model training to obtain the corresponding model intermediate information, and then the model intermediate information of the two network elements is fused to jointly train the machine learning model corresponding to the subscription content. Compared with separate training, in this manner, a model training speed can be multiplied by several times.

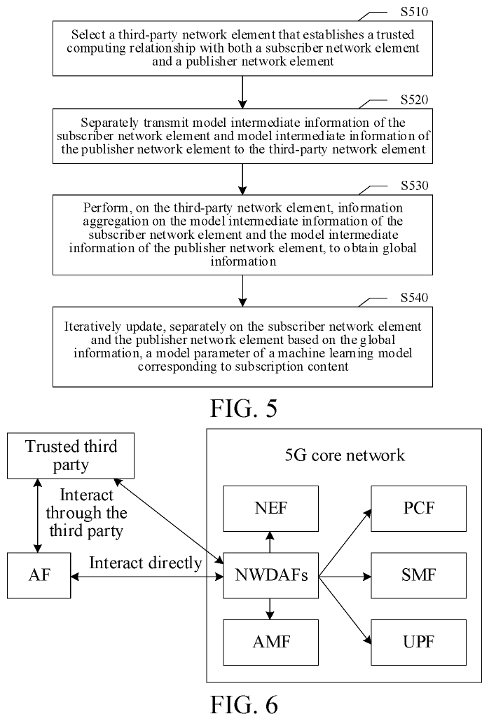

In some embodiments of the present disclosure, fusion of the model intermediate information may be performed by the trusted third party. FIG. 5 is a flowchart of training a machine learning model based on a third-party network element according to some embodiments of the present disclosure. As shown in FIG. 5, based on the foregoing embodiments, the training, on the subscriber network element based on the model intermediate information of the subscriber network element and the model intermediate information of the publisher network element, the machine learning model corresponding to the subscription content may include S510 to S540.
S510: Select the third-party network element that establishes the trusted computing relationship with both the subscriber network element and the publisher network element.
S520: Separately transmit the model intermediate information of the subscriber network element and the model intermediate information of the publisher network element to the third-party network element.
S530: Perform, on the third-party network element, information aggregation on the model intermediate information of the subscriber network element and the model intermediate information of the publisher network element, to obtain global information.
S540: Iteratively update, separately on the subscriber network element and the publisher network element based on the global information, a model parameter of the machine learning model corresponding to the subscription content; or iteratively update, on the subscriber network element based on the global information, a model parameter of the machine learning model corresponding to the subscription content.

Information aggregation is performed on the model intermediate information on the third-party network element, so that an iterative update process of the model parameter that originally needs to be performed on a plurality of network elements may be centralized on one network element. Therefore, network resource consumption and computing resource consumption for model training can be greatly reduced.

For a selection manner of the third-party network element, refer to detailed descriptions in other embodiments. Details are not described herein.

In some embodiments of the present disclosure, the subscriber network element and the publisher network element train, through federated learning, the machine learning model corresponding to the subscription content.

Federated learning is a machine learning method and is configured for training a model. The model may learn from data of a plurality of participants without centralizing data in one place. This method is applicable to a case related to privacy-sensitive data, because the method allows model training to be performed without sharing original data.

In some embodiments of the present disclosure, the subscriber network element and the publisher network element train, through vertical federated learning, the machine learning model corresponding to the subscription content; and a training sample possessed by the subscriber network element and a training sample possessed by the publisher network element have the same sample identifier and different features.

Federated learning includes two methods: horizontal federated learning and vertical federated learning. Horizontal federated learning means that the plurality of participants have different sample identifiers (IDs) but the same sample feature. Vertical federated learning means that the plurality of participants have the same sample ID but different sample features.

For example, the subscriber network element is the AF outside the core network in a 5G network, and a training sample possessed by the AF is performance data of the terminal device, for example, performance indicators such as a battle level and a memory utilization rate of the device. The publisher network element is the NWDAF inside the core network in the 5G network, and a training sample possessed by the NWDAF is a guaranteed bit rate (GBR) allocated to the terminal device.

In some embodiments of the present disclosure, the subscriber network element and the publisher network element implement joint modeling training through vertical federated learning. For example, in the 5G network, the service server may request an analysis result from the NWDAF, so that the NWDAF performs joint modeling by using information of a RAN, a UE, and the AF, analyzes a deduction result, and returns the result to the service server.

The following describes the network element interaction-based model training method in the present disclosure in detail with reference to a specific application scenario.

In an application scenario of the present disclosure, an AF usually intends to analyze a behavior or a QoE status of a user based on a network status. Therefore, some network information needs to be collected from a core network, but the core network does not intend to share the information with the AF due to a privacy problem. For example, a service needs some information like mobility information of a UE, but this type of information is on a core network side. Without this type of information, the service cannot accurately determine a current QoE level. For example, QoE needs to be determined by collecting network performance parameters (for example, a packet delay, a bit rate, and a packet loss) in a form of QoS indicators of the information.

FIG. 6 is a block diagram of an architecture of implementing network element interaction in an application scenario according to some embodiments of the present disclosure.

As shown in FIG. 6, according to the network element interaction-based model training method provided in some embodiments of the present disclosure, an AF may exchange information with an NWDAF of a 5G core network. If information about other network elements, for example, an NEF, a PCF, an SMF, an AMF, and a UPF, is not intended to be shared with the NWDAF, the NWDAF and these NFs may separately use the network element interaction-based model training method provided in embodiments of the present disclosure. In this case, two parties directly interact with each other, and network element interaction is performed on a premise that the two parties trust each other.

In another manner, a trusted third party is used as a trusted party of the AF and the NWDAF, and is responsible for exchange of intermediate information in interactive training. The trusted third party herein does not necessarily refer to a third party outside a 5G system. The third party is relative to the AF and the NWDAF or the core network during information exchange, and is trusted by default from a perspective of both the AF and the NWDAF, which are willing to exchange data to the trusted third party. The trusted third party herein may be a network element inside the 5G system, or may be any terminal or server outside the 5G system.

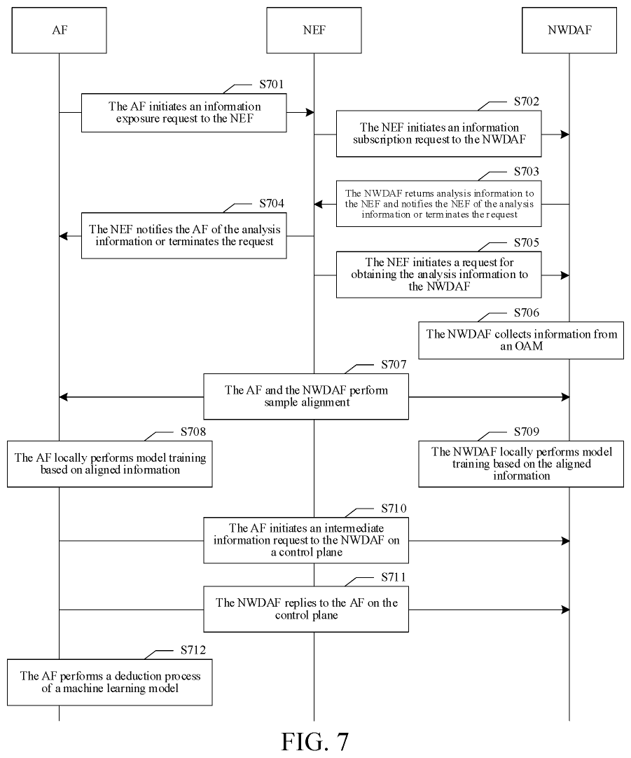

FIG. 7 is a flowchart of direct interaction between two network elements in an application scenario according to some embodiments of the present disclosure. As shown in FIG. 7, a process of direct interaction between the two network elements may include S701 to S712.
S701: An AF/over the top (OTT) server initiates an information exposure request to an NEF.

The information exposure request (Nnef_AnalyticsExposure request) is configured for requesting subscription to or unsubscription from data analysis information. The data analysis information, for example, may include feature/sample alignment information, and may further include model intermediate information such as a weight and a gradient.

The AF does not request original information of a network, and does not expose original information of the AF to the network, to ensure information exchange between the AF and an NWDAF on a premise that privacy is ensured.
S702: The NEF initiates an information subscription request to the NWDAF.

The NEF requests subscription to or unsubscription from the data analysis information by invoking a service. The service that can be invoked, for example, may include Nnef_AnalyticsExposure_Subscribe or Nnef_AnalyticsExposure_Unsubscribe (defined in 3GPP TS 23.502). The NEF is responsible for controlling analysis exposure mapping between an AF identifier and an allowed analysis ID, along with an associated parameter/parameter value.

If the NEF receives the request initiated by the AF, the NEF may authorize the AF and verify whether a user corresponding to the AF has a right to access a system. Assuming that the user has the right to access the system, the NEF may subscribe to or unsubscribe from the analysis information by invoking a service operation of Nnwdaf_AnalyticsSubscription_Subscribe or Nnwdaf_AnalyticsSubscription_Unsubscribe based on the request of the AF.
S703: The NWDAF returns the analysis information to the NEF and notifies the NEF of the analysis information or terminates the request.

If the NEF subscribes to the analysis information, the NWDAF notifies the NEF of the analysis information or terminates the request by invoking a service operation of Nnwdaf_AnalyticsSubscription_Notify.
S704: The NEF notifies the AF of the analysis information or terminates the request.

If the NEF receives a notification from the NWDAF, the NEF notifies the AF of the analysis information or terminates the request by invoking the service operation of Nnwdaf_AnalyticsSubscription_Notify defined in TS 23.502.
S705: The NEF initiates a request for obtaining the analysis information to the NWDAF.

The NEF requests the analysis information by invoking a service operation of Nnwdaf_AnalyticsInfo_Request. A parameter that may be provided by an NWDAF service consumer includes feature/sample alignment, inter-layer information (the weight and the gradient), and the like.
S706: The NWDAF collects information from an OAM.

Information that may be provided by the OAM for the NWDAF is clearly defined in 3GPP TS 23.288, and information that needs to be used herein mainly includes a channel quality indicator (CQI). Network information clearly defined in TS 23.288 may be further provided.

In a specification defined in 3GPP R18 , the NWDAF may collect information from another NWDAF, and another network element such as the NEF, a PCF, an SMF, and an AMF may also perform interactive information collection by using the solutions provided in some embodiments of the present disclosure. This case usually applies when another network element does not intend to expose information to the NWDAF. (The NWDAF may collect information from another NWDAF on a premise that the NWDAFs are different NWDAFs in the same region, and NWDAFs in different regions cannot share the information for a legal reason).
S707: The AF and the NWDAF perform sample alignment.

Sample alignment is configured for finding an intersection of cross-domain samples. The AF and the NWDAF may further align other interaction information such as gradient information and private key encryption information. The gradient information reflects an optimization direction of a machine learning model; and the private key encryption information refers to some highly sensitive information that needs encryption, for example, homomorphic encryption.
S708: The AF locally performs model training based on aligned information.
S709: The NWDAF locally performs model training based on the aligned information.

Training (model loss calculation) and testing may be performed on the machine learning model through an MTLF module of the NWDAF.

TS 23.288 clearly defines collaborative ML model training between the NWDAF MTLF and the NWDAF service consumer.
S710: The AF initiates an intermediate information request to the NWDAF on a control plane.
S711: The NWDAF replies to the AF on the control plane.

Reply information is intermediate information, and includes the gradient information, cross-layer information, and the like.
S712: The AF performs a deduction process of the machine learning model.

The foregoing process is repeatedly performed, and iterative update of the machine learning model may be completed based on direct interaction between the two network elements. In some implementations, the AF may directly interact with the NWDAF, to perform model training of vertical federated learning.

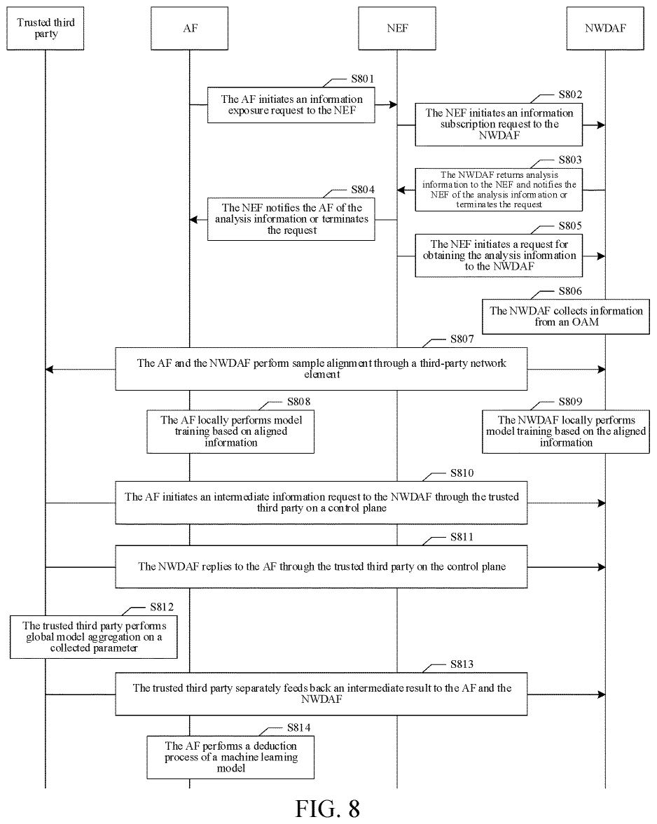

FIG. 8 is a flowchart of interaction performed through a third-party network element in an application scenario according to some embodiments of the present disclosure. As shown in FIG. 8, a process of direct interaction based on the third-party network element may include S801 to S814.
S801: An AF/OTT server initiates an information exposure request to an NEF.

The information exposure request (Nnef_AnalyticsExposure request) is configured for requesting subscription to or unsubscription from data analysis information. The data analysis information, for example, may include feature/sample alignment information, and may further include model intermediate information such as a weight and a gradient.

The AF does not request original information of a network, and does not expose original information of the AF to the network, to ensure information exchange between the AF and an NWDAF on a premise that privacy is ensured.
S802: The NEF initiates an information subscription request to the NWDAF.

The NEF requests subscription to or unsubscription from the data analysis information by invoking a service. The service that can be invoked, for example, may include Nnef_AnalyticsExposure_Subscribe or Nnef_AnalyticsExposure_Unsubscribe (defined in 3GPP TS 23.502). The NEF is responsible for controlling analysis exposure mapping between an AF identifier and an allowed analysis ID, along with an associated parameter/parameter value.

If the NEF receives the request initiated by the AF, the NEF may authorize the AF and verify whether a user corresponding to the AF has a right to access a system. Assuming that the user has the right to access the system, the NEF may subscribe to or unsubscribe from the analysis information by invoking a service operation of Nnwdaf_AnalyticsSubscription_Subscribe or Nnwdaf_AnalyticsSubscription_Unsubscribe based on the request of the AF.
S803: The NWDAF returns the analysis information to the NEF and notifies the NEF of the analysis information or terminates the request.

If the NEF subscribes to the analysis information, the NWDAF notifies the NEF of the analysis information or terminates the request by invoking a service operation of Nnwdaf_AnalyticsSubscription_Notify.
S804: The NEF notifies the AF of the analysis information or terminates the request.

If the NEF receives a notification from the NWDAF, the NEF notifies the AF of the analysis information or terminates the request by invoking the service operation of Nnwdaf_AnalyticsSubscription_Notify defined in TS 23.502.
S805: The NEF initiates a request for obtaining the analysis information to the NWDAF.

The NEF requests the analysis information by invoking a service operation of Nnwdaf_AnalyticsInfo_Request. A parameter that may be provided by an NWDAF service consumer includes feature/sample alignment, inter-layer information (the weight and the gradient), and the like.
S806: The NWDAF collects information from an OAM.

Information that may be provided by the OAM for the NWDAF is clearly defined in 3GPP TS 23.288, and information that needs to be used herein mainly includes a channel quality indicator (CQI). Network information clearly defined in TS 23.288 may be further provided.

In a specification defined in 3GPP R18 , the NWDAF may collect information from another NWDAF, and another network element such as the NEF, a PCF, an SMF, and an AMF may also perform interactive information collection by using the solutions provided in some embodiments of the present disclosure. This case usually applies when another network element does not intend to expose information to the NWDAF. (The NWDAF may collect information from another NWDAF on a premise that the NWDAFs are different NWDAFs in the same region, and NWDAFs in different regions cannot share the information for a legal reason).
S807: The AF and the NWDAF perform sample alignment through the third-party network element.

After a trusted third party separately confirms with the AF and the NWDAF, sample alignment is started through the third-party network element, to find an intersection of cross-domain samples. The AF and the NWDAF may further align other interaction information such as gradient information and private key encryption information. The gradient information reflects an optimization direction of a machine learning model; and the private key encryption information refers to some highly sensitive information that needs encryption, for example, homomorphic encryption.

In an implementation, the AF and the NWDAF may separately transmit respectively possessed sample feature names (IDs) to the trusted third party, obtain an intersection ID after private set intersection is performed by the trusted third party, and replies the intersection ID to the AF and the NWDAF on a control plane. Then, sample alignment may be separately performed on the AF and the NWDAF.
S808: The AF locally performs model training based on aligned information.
S809: The NWDAF locally performs model training based on the aligned information.

Training (model loss calculation) and testing may be performed on the machine learning model through an MTLF module of the NWDAF.

TS 23.288 clearly defines collaborative ML model training between the NWDAF MTLF and the NWDAF service consumer.
S810: The AF initiates an intermediate information request to the NWDAF through the trusted third party on the control plane.
S811: The NWDAF replies to the AF through the trusted third party on the control plane.

Reply information is intermediate information, and includes the gradient information, cross-layer information, and the like.
S812: The trusted third party performs global model aggregation on a collected parameter, to update a parameter of a global model.
S813: The trusted third party separately feeds back an intermediate result to the AF and the NWDAF.

The intermediate result includes one or more of gradient information update, private key encryption information update, update of another system statistical parameter, or the like.
S814: The AF performs a deduction process of the machine learning model.

The foregoing process is repeatedly performed, and iterative update of the machine learning model may be completed based on interaction through the third-party network element. In some implementations, the AF may interact with the NWDAF through the third-party network element, to perform model training of vertical federated learning.

It can be learned based on the descriptions of the foregoing embodiments and the application scenarios that in this solution, network element interaction between a core network and an application server is implemented, e.g., a service interaction process between the NWDAF and the AF is implemented, and the core network can expose an AI service to a service through the third party on a premise of privacy protection.

The operations of the method in the present disclosure is described in a specific order in the accompanying drawings, however, this does not request or imply that the operations are necessarily performed based on the specific order, or all shown operations are necessarily performed to implement a desired result. Additionally or alternatively, some operations may be omitted, a plurality of operations may be combined into one operation for execution, and/or one operation may be decomposed into a plurality of operations for execution, and the like.

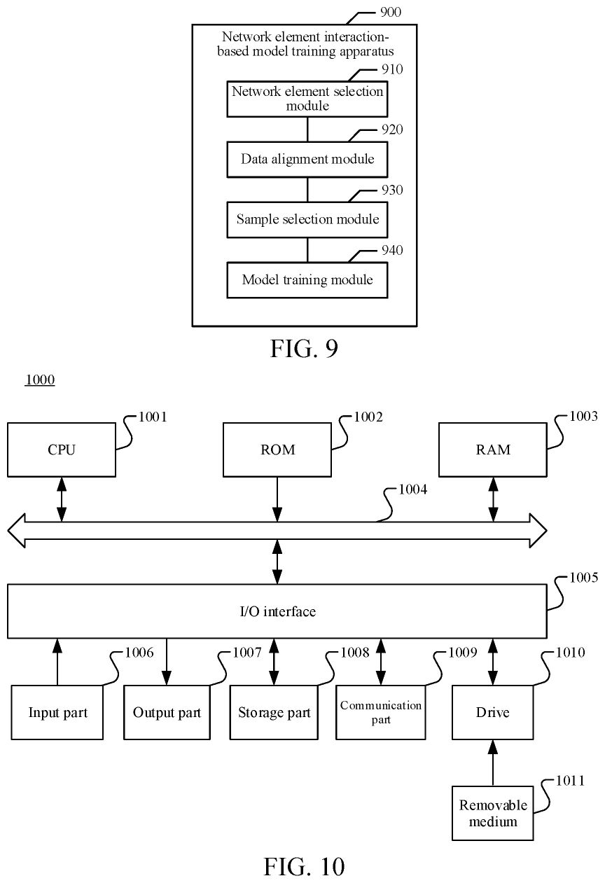

The following describes some embodiments of the present disclosure, which may be configured to perform the network element interaction-based model training method in the foregoing embodiments of the present disclosure. FIG. 9 is a schematic block diagram of a structure of a network element interaction-based model training apparatus according to some embodiments of the present disclosure. As shown in FIG. 9, the network element interaction-based model training apparatus 900 includes:
a network element selection module 910, configured to select, from a mobile communication network, a publisher network element that establishes an information subscription relationship with a subscriber network element, the information subscription relationship being configured for indicating that the publisher network element provides data analysis information related to original data of subscription content for the subscriber network element;
a data alignment module 920, configured to perform data alignment between the subscriber network element and the publisher network element, to obtain identification information of intersection data, the intersection data being data that has the same identification information between original data possessed by the subscriber and original data possessed by the publisher network element;
a sample selection module 930, configured to select publisher sample data from the publisher network element based on the identification information of the intersection data, and train, based on the publisher sample data, a machine learning model corresponding to the subscription content, to obtain model intermediate information of the publisher network element, the model intermediate information of the publisher network element belonging to the data analysis information; and
a model training module 940, configured to transmit the model intermediate information of the publisher network element to the subscriber network element, and train, on the subscriber network element based on the model intermediate information of the publisher network element, the machine learning model corresponding to the subscription content.

In some embodiments of the present disclosure, based on the foregoing technical solutions, the data alignment module includes:
a third-party network element selection module, configured to select a third-party network element that establishes a trusted computing relationship with both the subscriber network element and the publisher network element, the trusted computing relationship being configured for indicating that the third-party network element is capable of performing trusted computing on the original data respectively possessed by the subscriber network element and the publisher network element while data privacy is ensured;
an identification information transmission module, configured to separately transmit identification information of the original data respectively possessed by the subscriber network element and the publisher network element to the third-party network element;
an identification information alignment module, configured to perform, on the third-party network element, data alignment on the identification information of the original data respectively possessed by the subscriber network element and the publisher network element, to obtain the identification information of the intersection data; and
an intersection data transmission module, configured to separately transmits, by the third-party network element, the identification information of the intersection data to the subscriber network element and the publisher network element.

In some embodiments of the present disclosure, based on the foregoing technical solutions, the third-party network element selection module includes:
a network element set obtaining module, configured to obtain a first set of network elements that establishes a trusted computing relationship with the subscriber network element and a second set of network elements that establishes a trusted computing relationship with the publisher network element;
a first selection module, configured to select, if there is a common network element between the first set of network elements and the second set of network elements, the common network element as the third-party network element; and
a second selection module, configured to select, through a network exposure function in the mobile communication network if there is no common network element between the first set of network elements and the second set of network elements, a temporary network element as the third-party network element.

In some embodiments of the present disclosure, based on the foregoing technical solutions, the temporary network element is a network element that is selected from a third set of network elements maintained by the network exposure function and that is different from both the first set of network elements and the second set of network elements, and the temporary network element establishes a trusted computing relationship having specified validity duration with both the subscriber network element and the publisher network element through the network exposure function.

In some embodiments of the present disclosure, based on the foregoing technical solutions, the network element selection module includes:
an information exposure request module, configured to transmit an information exposure request of the subscriber network element to the network exposure function in the mobile communication network, the information exposure request carrying a network element identifier of the subscriber network element and the subscription content; and
an information subscription request module, configured to establish, on the network exposure function, a mapping relationship between the network element identifier of the subscriber network element and the subscription content, and initiate, to the publisher network element based on the subscription content, an information subscription request for establishing the information subscription relationship.

In some embodiments of the present disclosure, based on the foregoing technical solutions, the network element selection module further includes:
a network element permission verification module, configured to perform permission verification on the subscriber network element based on the network element identifier of the subscriber network element, the permission verification being configured for determining whether the subscriber network element has a system access permission; and
an execution rejection module, configured to reject execution of the information exposure request of the subscriber network element if a verification result of the permission verification indicates that the verification fails; and trigger, if the verification result of the permission verification indicates that the verification succeeds, execution of the operation of establishing, on the network exposure function, a mapping relationship between the network element identifier of the subscriber network element and the subscription content.

In some embodiments of the present disclosure, based on the foregoing technical solutions, the model training module includes:
a sample data selection module, configured to select subscriber sample data from the subscriber network element based on the identification information of the intersection data, and train, based on the subscriber sample data, the machine learning model corresponding to the subscription content, to obtain model intermediate information of the subscriber network element; and
an intermediate information training module, configured to train, on the subscriber network element based on the model intermediate information of the subscriber network element and the model intermediate information of the publisher network element, the machine learning model corresponding to the subscription content.

In some embodiments of the present disclosure, based on the foregoing technical solutions, the intermediate information training module is further configured to: select the third-party network element that establishes the trusted computing relationship with both the subscriber network element and the publisher network element; separately transmit the model intermediate information of the subscriber network element and the model intermediate information of the publisher network element to the third-party network element; perform, on the third-party network element, information aggregation on the model intermediate information of the subscriber network element and the model intermediate information of the publisher network element, to obtain global information; and iteratively update, on the subscriber network element based on the global information, a model parameter of the machine learning model corresponding to the subscription content.

In some embodiments of the present disclosure, based on the foregoing technical solutions, the subscriber network element is a network element outside a core network of the mobile communication network, and the publisher network element is a network element inside the core network of the mobile communication network.

In some embodiments of the present disclosure, based on the foregoing technical solutions, the subscriber network element is an application function configured to implement an application-layer service, and the publisher network element is a network data analytics function configured to provide a network data analytics service for the mobile communication network.

In some embodiments of the present disclosure, based on the foregoing technical solutions, the apparatus further includes:
a sample collection module, configured to initiate a sample collection request to an operation administration and maintenance network element in the mobile communication network through the network data analytics function; and obtain, based on the sample collection request, original data possessed by the network data analytics function.

In some embodiments of the present disclosure, based on the foregoing technical solutions, the original data possessed by the network data analytics function includes channel quality indicator information configured for indicating wireless channel quality.

Specific details of the network element interaction-based model training apparatus provided in some embodiments of the present disclosure are described in detail in the corresponding method embodiments, and are not described herein again.

FIG. 10 is a schematic block diagram of a structure of a computer system applicable to implement an electronic device according to some embodiments of the present disclosure.

The computer system 1000 of the electronic device shown in FIG. 10 is merely an example, and does not constitute any limitation on functions and use ranges of some embodiments of the present disclosure.

As shown in FIG. 10, the computer system 1000 includes a central processing unit (CPU) 1001, which may perform various suitable actions and processing based on a program stored in a read-only memory (ROM) 1002 or a program loaded to a random access memory (RAM) 1003 from a storage part 1008. The random access memory 1003 further has various programs and data required for system operations stored therein. The central processing unit 1001, the read-only memory 1002, and the random access memory 1003 are connected to each other via a bus 1004. An input/output interface (I/O interface) 1005 is also connected to the bus 1004.

The following components are connected to the input/output interface 1005: an input part 1006 including a keyboard, a mouse, and the like; an output part 1007 including a cathode ray tube (CRT), a liquid crystal display (LCD), a speaker, and the like; the storage part 1008 including a hard disk and the like; and a communication part 1009 including a network interface card such as a local area network card or a modem. The communication part 1009 performs communication processing through a network, for example, the Internet. A drive 1010 is also connected to the input/output interface 1005. A removable medium 1011, such as a magnetic disk, an optical disc, a magneto-optical disk, or a semiconductor memory, is mounted on the drive 1010, so that a computer program read from the removable medium is installed into the storage part 1008.

For example, based on some embodiments of the present disclosure, a process described in each method flowchart may be implemented as a computer software program. For example, some embodiments of the present disclosure includes a computer program product, which includes a computer program carried on a computer-readable medium, and the computer program includes program code configured for performing the method shown in the flowchart. In such an embodiment, the computer program may be downloaded and installed from the network and/or installed from the removable medium 1011 through the communication part 1009. When the computer program is executed by the central processing unit 1001, various functions limited in a system of the present disclosure are executed.

The computer-readable medium shown in some embodiments of the present disclosure may be a computer-readable signal medium or a computer-readable storage medium or any combination thereof. The computer-readable storage medium may be, for example, but is not limited to, an electrical, magnetic, optical, electromagnetic, infrared, or semiconductor system, apparatus, or device, or any combination thereof. A more specific example of the computer-readable storage medium may include but is not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disc read-only memory (CD-ROM), an optical storage device, a magnetic storage device, or any appropriate combination thereof. In the present disclosure, the computer-readable storage medium may be any tangible medium containing or storing a program, and the program may be used by or used in combination with an instruction execution system, an apparatus, or a device. In the present disclosure, the computer-readable signal medium may include a data signal propagated in a baseband or as part of a carrier, and computer-readable program code is carried therein. The data signal propagated in such a way may have a plurality of forms, including but not limited to an electromagnetic signal, an optical signal, or any appropriate combination thereof. The computer-readable signal medium may alternatively be any computer-readable medium other than the computer-readable storage medium. The computer-readable medium may send, propagate, or transmit the program that is used by or used in combination with the instruction execution system, apparatus, or device. The program code included in the computer-readable medium may be transmitted by using any suitable medium, including, but not limited to, a wireless medium, a wired medium, or the like, or any suitable combination thereof.

The flowcharts and block diagrams in the accompanying drawings illustrate possible system architectures, functions, and operations that may be implemented by a system, a method, and a computer program product according to some embodiments of the present disclosure. In this regard, each box in the flowchart or the block diagram may represent a module, a program segment, or a part of code. The module, the program segment, or the part of code includes one or more executable instructions configured for implementing specified logic functions. In some implementations used as substitutes, functions annotated in boxes may alternatively occur in a sequence different from that annotated in the accompanying drawings. For example, two blocks shown in succession may be actually performed basically in parallel, and sometimes may be performed in a reverse sequence, which is determined by an involved function. Each block in the flowchart or the block diagram and combinations of the blocks in the flowcharts or the block diagrams may be implemented by a dedicated hardware-based system that performs a specified function or operation, or may be implemented by a combination of dedicated hardware and computer instructions.

Although several modules or units of a device for performing actions are mentioned in the foregoing detailed descriptions, such division is not compulsory. Actually, according to some embodiments of the present disclosure, features and functions of two or more modules or units described above may be specified in one module or unit. On the contrary, features and functions of one module or unit described above may be further divided to be specified by a plurality of modules or units.

According to the descriptions of the foregoing implementations, a person skilled in the art may easily understand that the exemplary implementations described herein may be implemented by means of software, or may be implemented by combining software and corresponding hardware. Therefore, the technical solutions of the implementations of the present disclosure may be implemented in a form of a software product. The software product may be stored in a non-volatile storage medium (which may be a CD-ROM, a USB flash drive, a removable hard disk, or the like) or on a network, including several instructions for instructing a computing device (which may be a personal computer, a server, a touch terminal, a network device, or the like) to perform the methods according to the implementations of the present disclosure.

After considering this specification and practicing the present disclosure, a person skilled in the art may easily conceive of other implementations of the present disclosure. The present disclosure is intended to cover any variations, uses, or adaptive changes of the present disclosure. These variations, uses, or adaptive changes follow the general principles of the present disclosure and include common general knowledge or customary technical means in the art that are not disclosed in the present disclosure.

The present disclosure is not limited to the precise structures described above and shown in the accompanying drawings, and various modifications and changes may be made without departing from the scope of the present disclosure. The scope of the present disclosure is limited only by the appended claims.

What is claimed is:

1. A method for network element interaction-based model training, comprising:
selecting, from a mobile communication network, a publisher network element that is configured to establish an information subscription relationship with a subscriber network element, the information subscription relationship indicating that the publisher network element provides data analysis information related to original data of subscription content for the subscriber network element;
performing data alignment between the subscriber network element and the publisher network element, to obtain identification information of intersection data, the intersection data comprising the same identification information between original data possessed by the subscriber network element and original data possessed by the publisher network element;
selecting publisher sample data from the publisher network element based on the identification information of the intersection data;
updating, based on the publisher sample data, a machine learning model corresponding to the subscription content, to obtain model intermediate information of the publisher network element, the model intermediate information of the publisher network element corresponding to the data analysis information;
transmitting the model intermediate information of the publisher network element to the subscriber network element; and
updating, on the subscriber network element, the machine learning model corresponding to the subscription content based on the model intermediate information of the publisher network element.

2. The method according to claim 1, wherein the performing of data alignment between the subscriber network element and the publisher network element, to obtain the identification information of intersection data comprises:
selecting a third-party network element that is configured to establish a trusted computing relationship with both the subscriber network element and the publisher network element, the trusted computing relationship indicating that the third-party network element is capable of performing trusted computing on the original data possessed by the subscriber network element and the publisher network element respectively while ensuring data privacy;
transmitting identification information of the original data possessed by the subscriber network element and the publisher network element respectively to the third-party network element; and
performing, on the third-party network element, data alignment on the identification information of the original data possessed by the subscriber network element and the publisher network element respectively, to obtain the identification information of the intersection data.

3. The method according to claim 2, wherein the selecting of the third-party network element that is configured to establish the trusted computing relationship with both the subscriber network element and the publisher network element comprises:
obtaining information indicating first set of network elements a first set of network elements that is configured to establish the trusted computing relationship with the subscriber network element and a second set of network elements second set of network elements that is configured to establish the trusted computing relationship with the publisher network element;
selecting a common network element between the first set of network elements first set of network elements and the second set of network elements second set of network elements as the third-party network element; and
selecting, through a network exposure function in the mobile communication network based on not having the common network element between the first set of network elements first set of network elements and the second set of network elements second set of network elements, a temporary network element as the third-party network element.

4. The method according to claim 3, wherein the temporary network element is:
selected from a third set of network elements third set of network elements maintained by the network exposure function; and
different from both the first set of network elements first set of network elements and the second set of network elements second set of network elements, and
wherein the temporary network element is configured to establish the trusted computing relationship having specified validity duration with both the subscriber network element and the publisher network element through the network exposure function.

5. The method according to claim 3, wherein the selecting of the publisher network element that is configured to establish the information subscription relationship with the subscriber network element comprises:
transmitting an information exposure request of the subscriber network element to the network exposure function in the mobile communication network, the information exposure request comprising a network element identifier of the subscriber network element and the subscription content;
establishing, on the network exposure function, a mapping relationship between the network element identifier of the subscriber network element and the subscription content; and
initiating, to the publisher network element based on the subscription content, an information subscription request to establish the information subscription relationship.

6. The method according to claim 5, wherein before the establishing, on the network exposure function, the mapping relationship between the network element identifier of the subscriber network element and the subscription content, the method further comprises:
performing permission verification on the subscriber network element based on the network element identifier of the subscriber network element, to determine whether the subscriber network element has a system access permission;
rejecting execution of the information exposure request of the subscriber network element based on a failure of the permission verification; and
triggering, based on a success of the permission verification, execution of the operation of establishing, on the network exposure function, the mapping relationship between the network element identifier of the subscriber network element and the subscription content.

7. The method according to claim 2, wherein the updating, on the subscriber network element based on the model intermediate information of the publisher network element, the machine learning model corresponding to the subscription content comprises:
selecting subscriber sample data from the subscriber network element based on the identification information of the intersection data;
updating, based on the subscriber sample data, the machine learning model corresponding to the subscription content, to obtain the model intermediate information of the subscriber network element; and
updating, on the subscriber network element, the machine learning model corresponding to the subscription content, based on the model intermediate information of the subscriber network element and the model intermediate information of the publisher network element,.

8. The method according to claim 7, wherein the updating, on the subscriber network element, the machine learning model corresponding to the subscription content, based on the model intermediate information of the subscriber network element and the model intermediate information of the publisher network element comprises:
selecting the third-party network element that is configured to establish the trusted computing relationship with both the subscriber network element and the publisher network element;
transmitting the model intermediate information of the subscriber network element and the model intermediate information of the publisher network element to the third-party network element;
aggregate, on the third-party network element, the model intermediate information of the subscriber network element and the model intermediate information of the publisher network element, to obtain global information; and
updating, on the subscriber network element based on the global information, a model parameter of the machine learning model corresponding to the subscription content.

9. The method according to claim 1, wherein the subscriber network element is outside a core network of the mobile communication network, and
wherein the publisher network element is inside the core network of the mobile communication network.

10. The method according to claim 1, wherein the subscriber network element is an application function configured to implement an application-layer service, and
wherein the publisher network element is a network data analytics function configured to provide a network data analytics service for the mobile communication network.

11. The method according to claim 10, wherein before the selecting of the publisher sample data from the publisher network element based on the identification information of the intersection data, the method further comprises:
initiating a sample collection request to an operation administration and maintenance network element in the mobile communication network through the network data analytics function; and
obtaining, based on the sample collection request, the original data possessed by the network data analytics function.

12. The method according to claim 10, wherein the original data possessed by the network data analytics function comprises channel quality indicator information indicating wireless channel quality.

13. The method according to claim 1, wherein the subscriber network element and the publisher network element are configured to update, through federated learning, the machine learning model corresponding to the subscription content.

14. The method according to claim 1, wherein the subscriber network element and the publisher network element are configured to update, through vertical federated learning, the machine learning model corresponding to the subscription content, and
wherein a training sample possessed by the subscriber network element and a training sample possessed by the publisher network element have the same sample identifier but different features.

15. An apparatus for network element interaction-based model updating, comprising:
at least one memory configured to store computer program code; and at least one processor configured to read the program code and operate as instructed by the program code, the program code comprising:
network element selection code configured to cause the at least one processor to select, from a mobile communication network, a publisher network element configured to establish an information subscription relationship with a subscriber network element, the information subscription relationship indicating that the publisher network element provides data analysis information related to original data of subscription content for the subscriber network element;
data alignment code configured to cause the at least one processor to perform data alignment between the subscriber network element and the publisher network element, to obtain identification information of intersection data, the intersection data comprising the same identification information between original data possessed by the subscriber network element and original data possessed by the publisher network element;
sample selection code configured to cause the at least one processor to:
select publisher sample data from the publisher network element based on the identification information of the intersection data; and
update, based on the publisher sample data, a machine learning model corresponding to the subscription content, to obtain model intermediate information of the publisher network element, the model intermediate information of the publisher network element corresponding to the data analysis information;
model updating code configured to cause the at least one processor to transmit the model intermediate information of the publisher network element to the subscriber network element; and
update, on the subscriber network element, the machine learning model corresponding to the subscription content, based on the model intermediate information of the publisher network element.

16. The apparatus according to claim 15, wherein the data alignment code is further configured to cause the at least one processor to:
select a third-party network element that is configured to establish a trusted computing relationship with both the subscriber network element and the publisher network element, the trusted computing relationship indicating that the third-party network element is capable of performing trusted computing on the original data possessed by the subscriber network element and the publisher network element respectively while ensuring data privacy;
transmit identification information of the original data possessed by the subscriber network element and the publisher network element respectively to the third-party network element; and
perform, on the third-party network element, data alignment on the identification information of the original data possessed by the subscriber network element and the publisher network element respectively, to obtain the identification information of the intersection data.

17. The apparatus according to claim 16, wherein the data alignment code is further configured to cause the at least one processor to:
obtain information indicating a first set of network elements that is configured to establish the trusted computing relationship with the subscriber network element and a second set of network elements that is configured to establish the trusted computing relationship with the publisher network element;
select a common network element between the first set of network elements and the second set of network elements as the third-party network element; and
select, through a network exposure function in the mobile communication network based on not having the common network element between the first set of network elements and the second set of network elements, a temporary network element as the third-party network element.

18. The apparatus according to claim 17, wherein the temporary network element is:
selected from a third set of network elements maintained by the network exposure function; and
different from both the first set of network elements and the second set of network elements, and
wherein the temporary network element is configured to establish the trusted computing relationship having specified validity duration with both the subscriber network element and the publisher network element through the network exposure function.

19. The apparatus according to claim 17, wherein the network element selection code is further configured to cause the at least one processor to:
transmit an information exposure request of the subscriber network element to the network exposure function in the mobile communication network, the information exposure request comprising a network element identifier of the subscriber network element and the subscription content;
establish, on the network exposure function, a mapping relationship between the network element identifier of the subscriber network element and the subscription content; and
initiate, to the publisher network element based on the subscription content, an information subscription request to establish the information subscription relationship.

20. A non-transitory computer-readable storage medium, storing computer program code, when executed by at least one processor, causes the at least one processor to at least:
select, from a mobile communication network, a publisher network element that is configured to establish an information subscription relationship with a subscriber network element, the information subscription relationship indicating that the publisher network element provides data analysis information related to original data of subscription content for the subscriber network element;
perform data alignment between the subscriber network element and the publisher network element, to obtain identification information of intersection data, the intersection data comprising the same identification information between original data possessed by the subscriber network element and original data possessed by the publisher network element;
select publisher sample data from the publisher network element based on the identification information of the intersection data; and
update, based on the publisher sample data, a machine learning model corresponding to the subscription content, to obtain model intermediate information of the publisher network element, the model intermediate information of the publisher network element corresponding to the data analysis information;
transmit the model intermediate information of the publisher network element to the subscriber network element; and
update, on the subscriber network element, the machine learning model corresponding to the subscription content based on the model intermediate information of the publisher network element.
